(19) United States
(12) Patent Application Publication
(10) Pub. No.: US 2012/0218945 A1
(43) Pub. Date: Aug. 30, 2012

(54) Method and Arrangement for Random Access Diversity

(75) Inventors: Ali Behravan, Stockholm (SE); Robert Baldemair, Solna (SE)

(73) Assignee: TELEFONAKTIEBOLAGET LM ERICSSON (PUBL), Stockholm (SE)

(21) Appl. No.: 13/505,178

(22) PCT Filed: Nov. 25, 2009
(86) PCT No.: PCT/SE2009/051335

§ 371 Date: Apr. 30, 2012

(51) Int. Cl. H04W 74/08

(52) U.S. Cl. 370/328

(57) ABSTRACT

Methods and arrangements for enablement of transmission of a network node assisted random access request using transmit diversity. The methods and arrangements relate to providing information related to a non-transparent diversity scheme to a mobile terminal, which diversity scheme then is used by the mobile terminal when transmitting a network node assisted random access request.

### TECHNICAL FIELD

The invention relates to a method and an arrangement in a telecommunication system, in particular to transmit diversity for random access.

### BACKGROUND

In a cellular system, Random Access (RA) is the process where a mobile terminal, or UE (User Equipment), requests a connection setup for initial access, or for re-establishment of a radio link. In addition to the usage during initial access, RA is also used e.g. when the mobile terminal has lost the uplink synchronization in an idle or a low-power mode. Random access may also be used during a handover process, in order to setup a connection between the mobile terminal and the target base station.

In LTE, there are currently two possible types of RA: contention-based and contention-free RA. In a contention-based RA attempt, the mobile terminal selects a RA preamble at random from a set of possible preambles. In a contention-free RA attempt, the RA preamble to be used by the mobile terminal has been explicitly specified by the network node. Which one of these two types that should be used in a RA-attempt is decided by the network node. However, in the case of initial access, the RA is contention-based per default.

In situations such as handover, or when a UE 106 has lost synchronization, RA requests may be sent to the serving and/or target network node 104. Typically, such situations occur at the cell edge, where the signal-to-interference ratio (SIR) is relatively low. In a hexagonal cell structure 102, as illustrated in FIG. 1, the SIR can be as low as −3 dB at the cell edge. If channel effects such as large scale fading are taken into account, the SIR could be even lower. This limits the performance of random access, since RA requests transmitted by mobile terminals located in areas where the SIR is low may e.g. be lost or misinterpreted by the network node to which the RA-request is directed.

Attempts have been made to improve RA performance by applying transmit diversity. For example, in the published international application WO2007/120019, a beam forming scheme is applied to the transmission of RA requests. However, since the network node, which is to receive e.g. an initial RA request, does not have much, if any, information about the parameters used by the mobile terminal when transmitting the RA request, the diversity schemes which can be used for all RA attempts are limited to transparent diversity schemes, which do not require prior information in the network node, as the beam forming scheme described in WO2007/120019. Other examples of transparent diversity schemes which may be used are small delay cyclic delay diversity and time-switched transmit diversity, where consecutive RA attempts are transmitted from different antennas. Such diversity schemes typically provide rather low performance gain.

Considering the above, there is still room for improvement regarding random access performance

### SUMMARY

It would be desirable to obtain an improved RA performance. It is an object of the invention to address the performance of RA attempts. Further it is an object of the invention to provide methods and arrangements for enabling the use of relatively advanced diversity schemes in RA attempts.

According to one aspect, a method is provided in a mobile terminal, for transmission of a random access request using transmit diversity. The method involves receiving, from a network node, a communication relating to network node assisted random access, where the received communication comprises information related to a non-transparent diversity scheme. The method further involves transmitting the network node assisted random access request to a network node, using more than one transmit antenna and applying the non-transparent diversity scheme.

According to another aspect, an arrangement is provided in a mobile terminal, for transmission of a random access request to a network node, using transmit diversity. The arrangement comprises more than one transmit antenna, and different functional units adapted to perform different tasks in accordance with the method described above. For example, the arrangement comprises a receiving unit for receiving, from a network node, a communication relating to network node assisted random access, where the communication comprises information related to a non-transparent diversity scheme. The arrangement further comprises a transmitting unit for transmitting the network node assisted random access request to a network node, using more than one transmit antenna and applying the non-transparent diversity scheme.

The above method and arrangement, respectively, may be used to improve the performance of network node assisted RA attempts by enabling the use of non-transparent diversity schemes for the transmission of RA requests.

The above described method and arrangement may be implemented in different embodiments, comprising one or more of the following possible features:

The information related to a non-transparent diversity scheme could be received from a serving network node and the network node assisted random access request could be transmitted to the same serving network node.

In a handover situation, the information related to a non-transparent diversity scheme could be received from the serving network node, and the network node assisted random access request could be transmitted to a target network node.

The received information could either be generated in the serving network node or in the target network node. When the information is generated in the serving network node, the serving network node should, in addition to providing the generated information to the mobile terminal, also provide the generated information to the target network node. When the information is generated in the target network node, the generated information is provided to the mobile terminal via the serving network node, which already has an established connection to the mobile terminal.

The received information may relate to more than one random access preamble, e.g. may comprise one or more Zadoff-Chu (ZC)sequences and one or more related cyclic shifts to be made of the ZC-sequences.

The received information could be used in order to generate the more than one random access preambles, to which the information relates, i.e. more than one random access preamble could be generated according to the received information.

The generated random access preambles could be used on at least two transmit antennas, i.e. a first preamble is used on at least a first antenna, and a second preamble is used on at least a second antenna, when transmitting the network node assisted random access request.

According to yet another aspect, a method is provided in a network node, for supporting transmission of a random access attempt of a mobile terminal in a wireless communication system. The method involves obtaining information related to a non-transparent diversity scheme to be used by the mobile terminal when transmitting a network node assisted random access request to a network node. The method further involves transmitting a communication related to network node assisted RA to the mobile terminal, where the communication comprises the obtained information related to a non-transparent diversity scheme to be used by the mobile terminal.

According to yet another aspect, an arrangement is provided in a network node, for supporting transmission of a random access attempt of a mobile terminal in a wireless communication system. The arrangement comprises different functional units adapted to perform different tasks in accordance with the network node-related method described above. The arrangement comprises an obtaining unit for obtaining information on a non-transparent diversity scheme to be used by the mobile terminal when transmitting a network node assisted random access request to a network node. The arrangement further comprises a transmitting unit for transmitting a communication related to network node assisted RA to the mobile terminal, where the communication comprises the obtained information related to a non-transparent diversity scheme to be used by the mobile terminal

The above network node-related method and arrangement may respectively be used to improve the performance of network node assisted RA attempts by enabling the use of non-transparent diversity schemes in a mobile terminal, for the transmission of RA requests.

The above described network node-related method and arrangement may be implemented in different embodiments, comprising one or more of the following possible features:

The obtaining of information related to a non-transparent diversity scheme could comprise generating, e.g. calculating, the information within the network node.

Alternatively, the obtaining of information related to a non-transparent diversity scheme could comprise obtaining the information from another network node, e.g. from a target network node in a handover situation.

The obtained information could be related to at least two random access preambles to be used on at least two transmit antennas of the mobile terminal.

The above features, which could be combined in different embodiments have basically been described in terms of actions. However, the described arrangements allow corresponding embodiments, where different functional units are adapted to carry out the above described features and actions.

### BRIEF DESCRIPTION OF THE DRAWINGS

The invention will now be explained in more detail by means of exemplary embodiments and with reference to the accompanying drawings, in which:

FIG. 1 is a schematic view illustrating a mobile terminal in a cell

FIG. 2a is a signalling scheme illustrating RA signalling between a mobile terminal and a network node according to one embodiment.

FIGS. 2b-c are signalling schemes illustrating RA signalling between a mobile terminal, a serving network node and a target network node, in a handover situation, according to different embodiments.

FIGS. 3a-b are flow charts illustrating embodiments of method steps in a mobile terminal.

FIGS. 4a-b are block diagrams illustrating embodiments of an arrangement in a mobile terminal.

FIG. 5 is a flow chart illustrating an embodiment of method steps in a network node.

FIG. 6 is a block diagram illustrating an embodiment of an arrangement in a network node.

FIGS. 7-9 are block schemes illustrating different embodiments of the transmission chain between a mobile terminal and a network node.

FIG. 10 shows an embodiment of an arrangement in a mobile terminal.

FIG. 11 shows an embodiment of an arrangement in a network node.

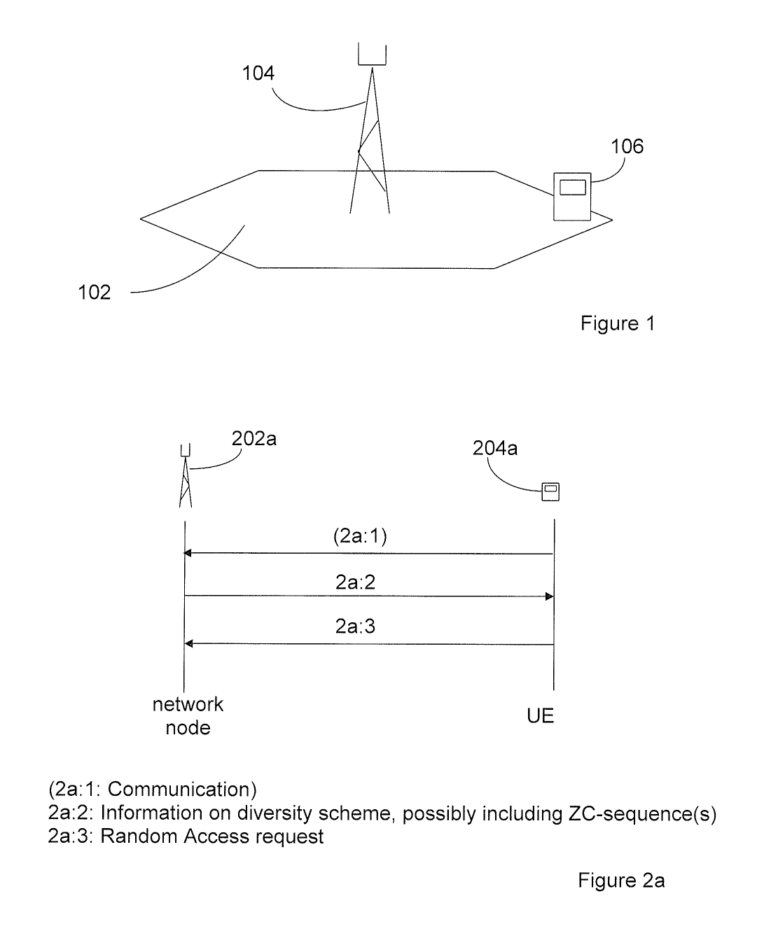

### DETAILED DESCRIPTION

Briefly described, a solution is provided for improving the performance of RA by using high performance transmit diversity in certain RA-attempts.

Random access is frequently/commonly associated with initial access and other non-assisted access attempts. It is previously known to improve the performance of RA attempts by using transparent diversity schemes, i.e. diversity schemes which do not require prior knowledge in the receiver. Such diversity schemes can be used in initial access attempts, where the receiver has no previous knowledge of the transmitting entity.

However, a substantial part of all RA-attempts in a wireless communication system are related to handover or synchronization, i.e. not to initial access. Therefore, a substantial part of the RA-attempts could be made network node assisted. Thus, a transmit format for network node assisted RA could be created, in which a network node may provide information to a mobile terminal concerning e.g. more than one RA preamble and/or other information concerning a transmit diversity scheme. Such a possibility would enable the use of more advanced transmit diversity schemes, which require knowledge at the receiver, in a part of all RA attempts, and thereby attain a relatively high performance gain in said part of the RA attempts. An example of a network node assisted RA is the contention-free RA in LTE.

### Some Definitions:

Within this document some expressions will be used when discussing the random access attempts and diversity schemes, which will be briefly defined here.

The terms “non-transparent” or “advanced” diversity schemes are used as meaning diversity schemes which require prior information or “knowledge” in a receiver, regarding which transmit diversity scheme and which parameters that are used by the transmitter. Examples of non-transparent diversity schemes are: large delay cyclic delay diversity, Alamouti, time-switched transmit diversity and frequency-switched transmit diversity. A transmit diversity scheme which requires knowledge in the receiver, but where the knowledge is not conveyed to the receiver from a network node, but obtained by the receiver by means of blind detection, is also regarded as a non-transparent diversity scheme.

The network nodes discussed within this document could be e.g. base stations, relay nodes, or other network nodes having similar functionality.

In order for a mobile terminal to be able to perform transmit (TX) diversity in the uplink (UL), it should be equipped with more than one antenna. Mobile terminals comprising more than one antenna is a potential feature in future communication systems, and is drafted e.g. in the 3GPP specifications for LTE Rel-10. The term “antenna” is used in the meaning “antenna port” or “virtual antenna”. The physical antenna connected to one antenna port could comprise one or more antenna elements.

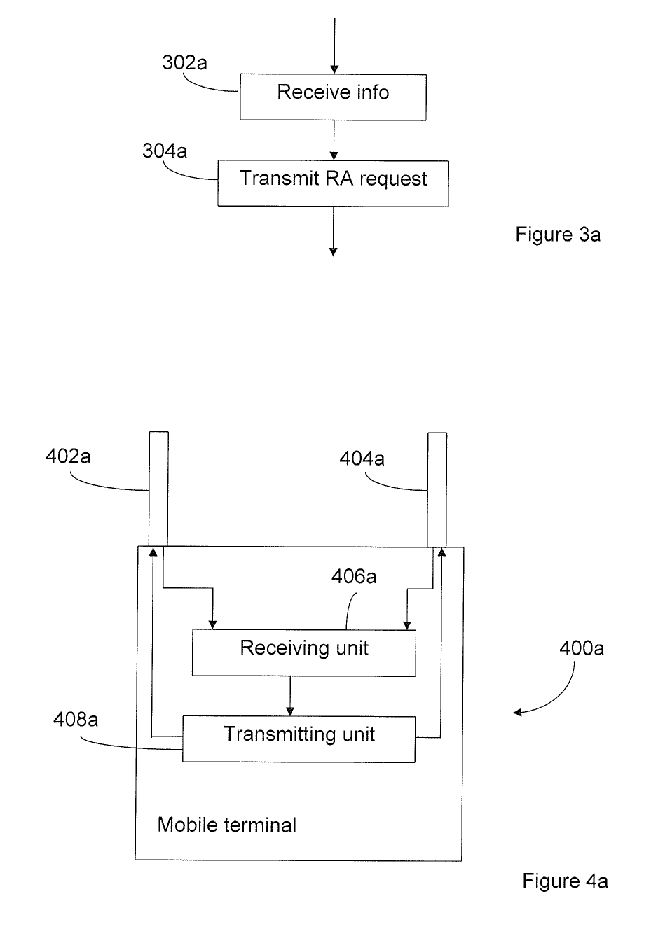

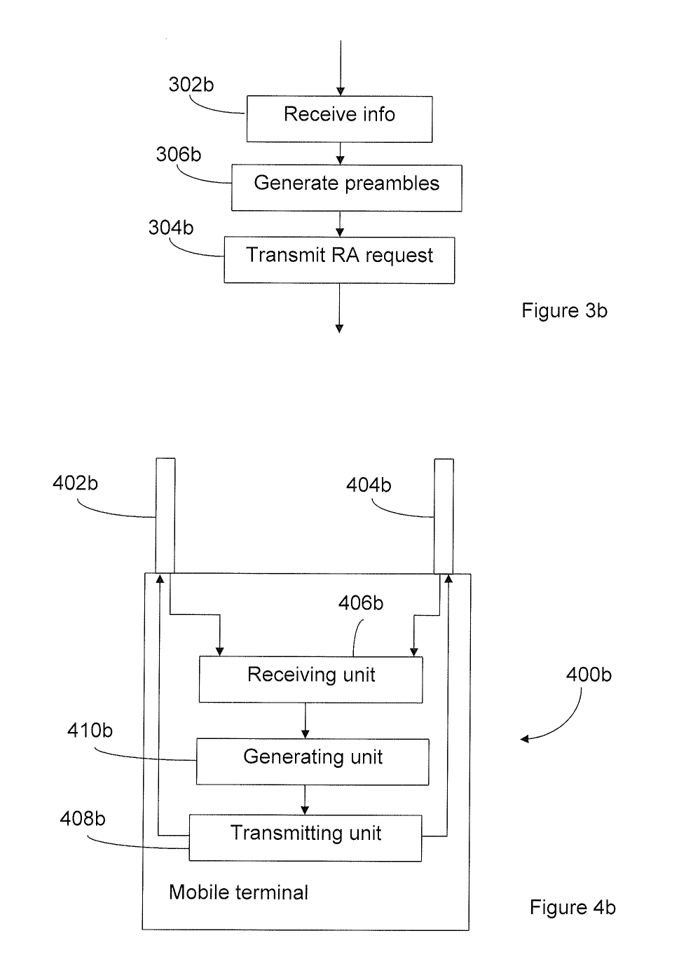

FIG. 3a illustrates method steps to be performed in a mobile terminal in a random access situation, according to one embodiment of the invention. Initially, in a first step 302a, information related to a non-transparent diversity scheme is received from a network node. Then, in a next step 304a, a random access request is transmitted to the network node, using more than one transmit antenna and applying the non-transparent diversity scheme, of which information previously was received from the network node. Alternatively, the RA request is transmitted to a network node other than the one providing the diversity scheme information, e.g. to a target network node in a handover situation. Such a situation will be further described later below.

The method steps 302b and 304b, illustrated in FIG. 3b, are similar to the method steps with corresponding names in FIG. 3a. FIG. 3b, however, also illustrates a method step 306b wherein more than one random access preamble is generated according to the information received in step 302b, according to one embodiment. The plurality of generated random access preambles are then used on at least two transmit antennas, i.e. a first preamble is used on at least a first antenna, and a second preamble is used on at least a second antenna, when transmitting the network node assisted random access request in step 304b.

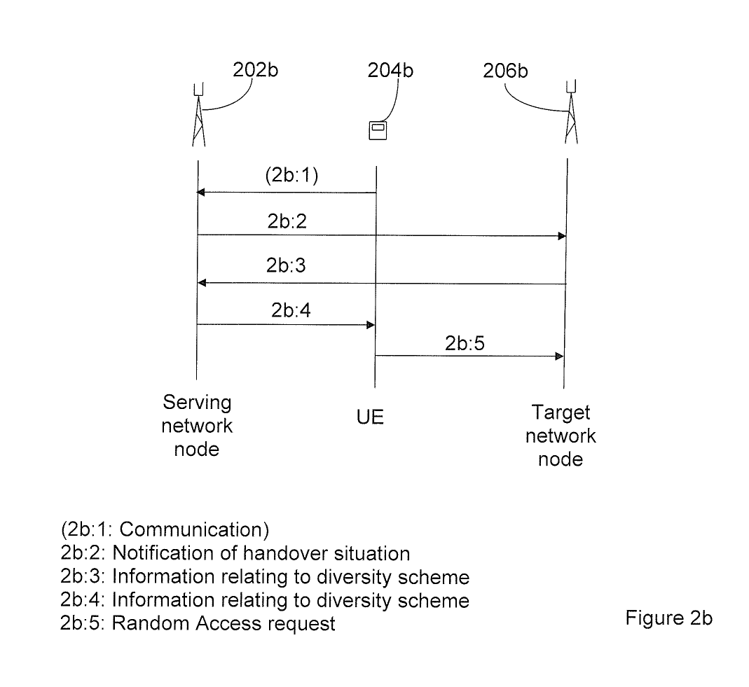

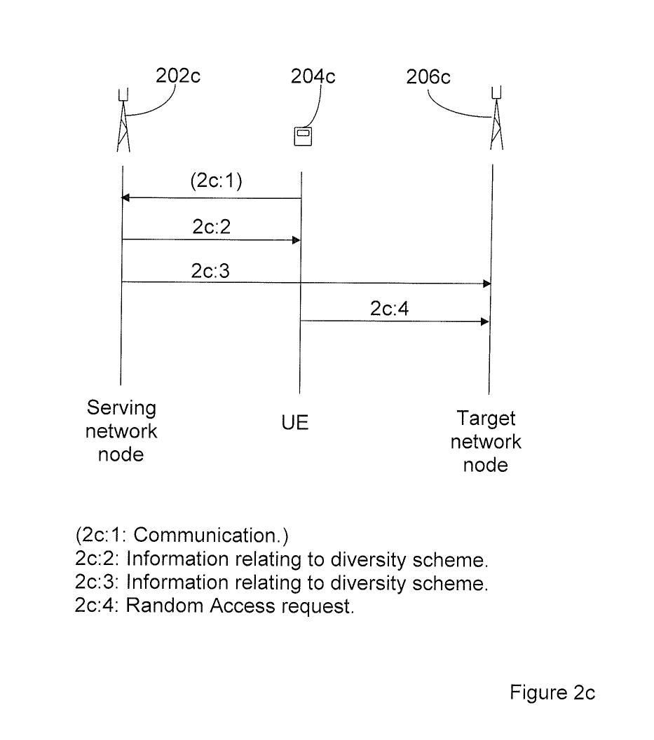

A network node assisted random access scenario requires that the network node has information on the mobile terminal, such as qualities, e.g. number of transmit antennas, and situation, e.g. if it has lost synchronization, the pathloss of the terminal to the serving and neighbouring eNodeBs or is about to perform a handover. This information may be obtained in ordinary communication with the mobile terminal, or be provided e.g. by a network node in a neighbouring cell. An example of signalling in a network node assisted random access attempt according to one embodiment is illustrated in FIG. 2a. First, explicit or implicit information on the mobile terminal is provided to the network node 202a, in this case through an ordinary communication 2a:1, not related to random access, from the mobile terminal 204a. The network node 202a then has information which enables it to determine that the mobile terminal should make a random access attempt, and generates information on a suitable non-transparent diversity scheme, and sends the generated information 2a:2 to the mobile terminal 204a. Alternatively, as illustrated in FIG. 2b, the serving network node 202b contacts 2b:2 a target network node 206b for handover, which target network node 206b then may provide the serving network node with information 2b:3 on a suitable non-transparent diversity scheme, which information then is transmitted 2b:4 by the serving network node to the mobile terminal 204b. The information may comprise indications of one or more root Zadoff-Chu sequences (ZC) and information of cyclical shifts to be made on the ZC sequence(s). Alternatively, or also, other information regarding the suitable non-transparent diversity scheme may be provided. The mobile terminal then may use the non-transparent diversity scheme when transmitting a random access request 2a:3, 2b:5 to the network node. The request 2a:3, 2b:5 can be properly received by the network node 202a, 206b, since the network node has the information necessary in order to process the received signals in an adequate way. Another possibility in e.g. a handover situation according to one embodiment, is illustrated in FIG. 2c, where a serving network node 202c generates information regarding a non-transparent diversity scheme, and provides 2c:2 this information to the mobile terminal 204c, which is to be handed over, and 2c:3 to the target network node 206c. The mobile terminal 204c may then send, and the target network node 206c may then receive, a network node assisted RA request 2c:4.

Below, an example arrangement adapted to enable the performance of the above described procedure in a mobile terminal will be described in connection with FIG. 4a. FIG. 4a, which is a block diagram, illustrates an embodiment of an arrangement 400a in a mobile terminal. The arrangement is adapted to transmit a network node assisted random access request to a network node. The arrangement comprises more than one transmit antenna, in this example the two antennas 402a and 404a, but it could be more than two antennas, e.g. four. The arrangement further comprises a receiving unit 406a, which is adapted to receive information on a non-transparent diversity scheme from a network node. The arrangement further comprises a transmitting unit 408a, which is adapted to transmit the network node assisted random access request to a network node, using both of the transmit antennas and applying the non-transparent diversity scheme.

The transmission could be performed using different random access preambles on at least two transmit antennas, where information on the different preambles is provided by the network node generating the information on the non-transparent diversity scheme.

FIG. 4b is a block diagram, which illustrates an embodiment of an arrangement 400b in a mobile terminal, which is similar to the arrangement illustrated in FIG. 4a. FIG. 4b, however, also illustrates a generating unit 410b, which is adapted to generate more than one random access preamble according to the information relating to a non-transparent diversity scheme received in the receiving unit 406b. The transmitting unit 408b is further adapted to use the different random access preambles generated in the generating unit 410b on at least two transmit antennas, i.e. a first preamble is used on at least a first antenna, and a second preamble is used on at least a second antenna, when transmitting the network node assisted random access request.

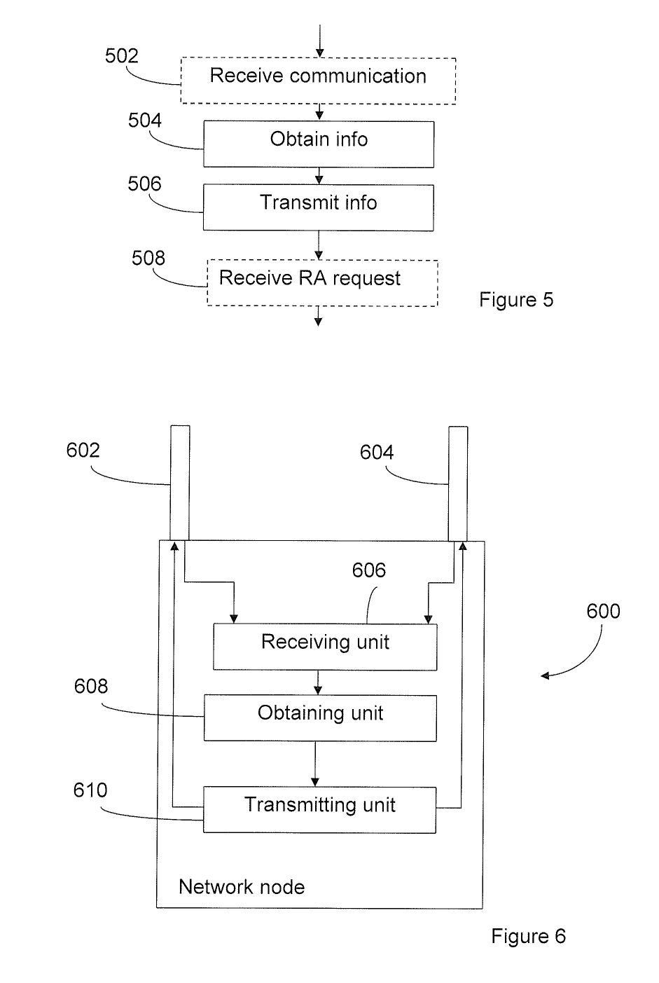

FIG. 5 illustrates method steps to be performed in a network node in a random access situation, according to one embodiment of the invention. Initially, in a first step 502, a communication is received from another network entity comprising e.g. information which enables the network node to determine that the mobile terminal should make a random access attempt, and/or information concerning the capabilities of the mobile terminal. Alternatively, the network node may be assumed to have obtained information concerning the mobile terminal capabilities, e.g. capability of using transmit diversity, at some other point in time, e.g. when connecting to the current cell. Then, in a next step 504, information related to a non-transparent diversity scheme to be used by the mobile terminal when transmitting a network node assisted random access request to a network node, is generated. The network node, to which the mobile terminal is to transmit the RA request, could be the network node generating the diversity information, but not necessarily. For example, the diversity information could be generated by a serving network node, and the RA request be sent to a target network node, where the serving network node also provides the diversity information to the target network node. Thereafter, in a next step 506, the generated information is transmitted to the mobile terminal. The network node transmitting the diversity information to the terminal could be the same as the network node generating the information, but not necessarily. For example, the diversity information could be generated by the target network node, and the diversity information then be forwarded to the serving network node, which transmits the information to the mobile terminal. Alternatively, the diversity information could be generated in another, possibly a central, entity in the network, which is capable of generating the appropriate diversity information, and providing it to the parties concerned. The generation and provision of diversity information could be triggered by e.g. a communication from a serving network node. Then, a random access request transmitted using the non-transparent diversity scheme may be adequately received, which is illustrated by the step 508.

Below, an example arrangement adapted to enable performance of embodiments of the described procedure in a network node will be described.

FIG. 6, which is a block diagram, illustrates an embodiment of an arrangement 600 in a network node. The arrangement is adapted to support a mobile terminal in making a random access attempt. The arrangement comprises at least one antenna, in this example the two antennas 602 and 604. The arrangement further comprises a receiving unit 606, which is adapted to receive information on a mobile terminal. The arrangement further comprises an obtaining unit 608, which is adapted to obtain information on a non-transparent diversity scheme to be used by the mobile terminal when transmitting a random access request to the network node, or to another network node, as will be described further below. The obtaining of information may comprise generating, e.g. calculating the information within the network node, or alternatively, the information on a non-transparent diversity scheme is received via the receiving unit 606 from another network node, e.g. a target network node or a central node. The arrangement further comprises a transmitting unit 610, which is adapted to transmit the information on the non-transparent diversity scheme to the mobile terminal. The receiving unit 606 is further adapted to receive a random access request from a mobile terminal, which is transmitted using at least two antennas and the non-transparent diversity scheme. The network node is assumed to have an interface towards other network nodes, such as e.g. the X2-interface in LTE.

It should be noted that FIGS. 4a-b and 6 merely illustrate various functional units in a mobile terminal and a network node in a logical sense. However, the skilled person is free to implement these functions in practice using any suitable software and/or hardware means. Thus, the invention is generally not limited to the shown structure of the arrangements in a mobile terminal or network node. The procedure steps illustrated in FIGS. 3a-b and 5 are also illustrated in a logical sense.

In case where RA is used for handover, the above outlined procedure is slightly different: in a handover situation, the target network node, e.g. an eNodeB that controls the cell the mobile terminal will connect to, is informed by the serving network node, e.g. an eNodeB that controls the cell the terminal is currently connected to, about e.g. the approaching handover and terminal capabilities of the mobile terminal, which is to be handed over. Based on this information, the target eNodeB may generate, e.g. calculate, the required parameters for the non-transparent transmit diversity scheme and forward these parameters, via the serving eNodeB, to the mobile terminal, which is to be handed over. Alternatively, the serving network node can generate, e.g. calculate, the required transmit diversity parameters and inform both the mobile terminal and the target network node.

Below, the procedure of RA will be described in more detail: One step in a RA procedure is the transmission of a RA preamble from a mobile terminal to a network node. In e.g. LTE release 8, there are 64 RA preamble sequences available per cell, which could be used for contention-based or contention-free RA-attempts. In a contention-based RA-attempt, the mobile terminal selects a RA preamble sequence at random from a set, which set is known to both the mobile terminal and the network node. If the mobile terminal is requested by a network node to perform a contention-free RA-attempt, the RA preamble to be used is explicitly specified by the network node.

Random access preambles are generated from cyclic shifts of root Zadoff-Chu (ZC) sequences. The length of the Zadoff-Chu sequence depends on the preamble format. For preamble formats 0-3 in LTE, which are the most common of the five currently existing formats in LTE, the length is 839 samples. This length gives the processing gain in the detection of the preamble. The number of orthogonal sequences that can be derived from one root ZC sequence depends on the cyclic shift length A. In smaller cells, a small cyclic shift can be used, resulting in that a larger number of cyclically shifted sequences can be derived from each root ZC sequence used in that cell.

A root ZC sequence is generated as:

$${x}_{u} ( n ) = {e}^{- j \frac{π un ( n + 1 )}{{N}_{ZC}}} ; 0 \leq n \leq {N}_{ZC} - 1 , \\ 1 \leq u \leq {N}_{ZC} - 1 \qquad ( 1 )$$

where u is the index of the sequence and N_{ZC} is the length of the sequence. A favorable property of ZC sequences is that they are CAZAC (Constant Amplitude and Zero AutoCorrelation) sequences, which make them ideal for being used as preamble. Another favorable quality of ZC sequences is that the DFT of a ZC sequence is another ZC sequence, which makes it easy to create ZC sequences in either the time or the frequency domain.

At the network node, which receives the transmitted RA preamble, the received sequence is correlated with root ZC sequences. By observing the output of the correlators, it is possible to detect which root ZC sequence and what cyclic shift that has been used, and also what the round-trip time of the channel is, which is related to how far from the network node the mobile terminal is located. This is possible due to the ideal auto-correlation properties of cyclically shifted ZC sequences.

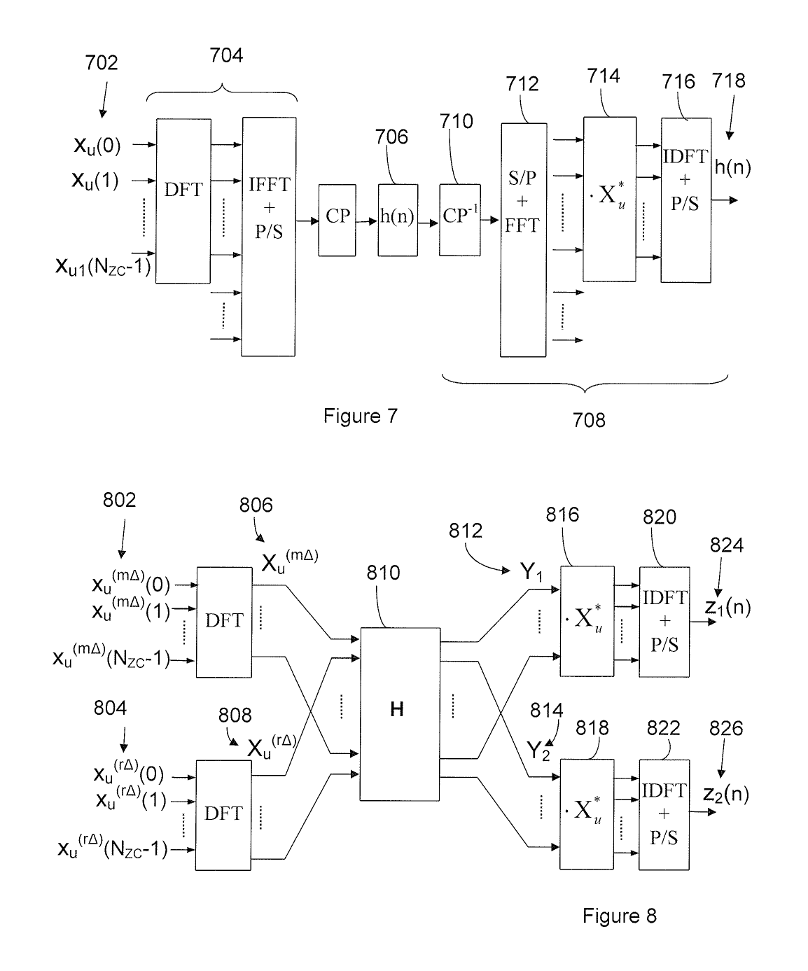

FIG. 7 shows a block diagram of the random access preamble generation and reception in the uplink of LTE. In this figure, a root ZC sequence u with no cyclic shift is used for the sake of simplicity. The sequence xᵤ(n) 702 is generated according to (1) and then transmitted using a single carrier frequency division multiple access (SC-FDMA) modulator 704. After the channel 706, and at the receiver 708, the cyclic prefix is first removed 710, and then the frequency domain sequence is formed by taking FFT 712 of the sequence. The frequency domain sequence is then element-wise multiplied by Xᵤ^{*} 714, and the result passes through an IDFT and a parallel-to-serial transform 716 to get a shifted impulse response 718.

When a cyclically shifted ZC sequence with a cyclic shift of mΔ is used, the preamble could be described as: xᵤ(n+mΔ modN_{ZC}). If the basic cyclic shift A is larger than the maximum roundtrip time plus the delay spread in a cell, then the sequences are orthogonal at the receiver. In this case the detected signal will be the channel impulse response at h(n+mΔ mod N_{ZC}).

Below, embodiments of the invention will be described, where a transmit diversity scheme in which two or more RA preambles are used, is used for improving RA performance. Two cases will be described: a first case where all TX antennas use the same root sequence, only with different cyclic shifts; and a second case where different root sequences are used for different TX antennas or branches. In the following examples, two transmit antennas and two receiver antennas are used. However, the inventive concept is directly applicable to the use of more than two transmit, and one or more receive antennas.

The first case is described in connection with FIG. 8. FIG. 8 shows a schematic block diagram of deploying random access with 2 TX antennas, and using the same ZC root sequence u to generate one RA preamble 802, 804 for each of the two TX antennas, according to one embodiment. In this example, two receive (RX) antennas are used, i.e. it is a 2×2 MIMO situation. In FIG. 8 the equivalent frequency domain channel 810 is used, where the matrix H is a block diagonal matrix with each block representing the 2×2 channel matrix for one frequency component.

In this example, it is assumed that the two RA preambles can be generated from the same ZC root sequence u, only with different cyclic shifts mΔ and rΔ. The received frequency domain sample after the FFT at subcarrier k, which is a part of the equivalent frequency channel 810, is:

Y₁(k)=H₁₁(k)Xᵤ^{(mΔ)}(k)+H₁₂(k)Xᵤ^{(rΔ)}(k)

Y₂(k)=H₂₁(k)Xᵤ^{(mΔ)}(k)+H₂₂(k)Xᵤ^{(rΔ)}(k) (1)

where the superscripts (mΔ) represents a cyclic shift of mΔ. The quantity Hᵢⱼ(k) is element (i, j) of the k-th block matrix. Then after the point-wise multiplication 816, 818 at each of the two branches we have:

Y₁(k)·Xᵤ^{*}(k)=H₁₁(k)Xᵤ^{(mΔ)}(k)·Xᵤ^{*}(k)+H₁₂(k)Xᵤ^{(rΔ)}(k)·Xᵤ^{*}(k)

Y₂(k)·Xᵤ^{*}(k)=H₂₁(k)Xᵤ^{(mΔ)}(k)·Xᵤ^{*}(k)+H₂₂(k)Xᵤ^{(rΔ)}(k)·Xᵤ^{*}(k) (3)

After the IDFT and parallel to serial conversion 820, 822, the received time domain signal is 824, 826:

z₁(n)=h₁₁(n+mΔ modN_{ZC})+h₁₂(n+rΔ modN_{ZC}); n=0,1, . . . , N_{ZC}−1

z₂(n)=h₂₁(n+mΔ modN_{ZC})+h₂₂(n+rΔ modN_{ZC}); n=0,1, . . . , N_{ZC}−1 (2)

Since it is assumed that the support of each impulse response, i.e. maximum round trip time plus delay spread, is limited to Δ, it is sufficient, on each of the received antennas, to extract the received signal with delay mΔ, and delay rΔ, over the time interval 0≦n≦Δ−1. The signals can then be combined as:

$${\vert {z}_{1} ( n - m Δ mod {N}_{ZC} ) \vert}^{2} + {\vert {{z}_{1} ( n - r Δ mod {N}_{ZC} \vert}^{2} + \vert {z}_{2} ( n - m Δ mod {N}_{ZC} ) \vert}^{2} + {\vert {z}_{2} ( n - r Δ mod {N}_{ZC} ) \vert}^{2} = {\vert {h}_{11} ( n ) \vert}^{2} + {\vert {h}_{12} ( n ) \vert}^{2} + {\vert {h}_{21} ( n ) \vert}^{2} + {\vert {h}_{22} ( n ) \vert}^{2} ; \\ n = 0 , 1 , … , Δ - 1 \qquad ( 3 )$$

which is used to get an estimate of the delay, i.e. the time delay within the cyclic shift zone until the impulse response starts to correspond to the round trip time. It should be noted that the combining interval of the output signals z(n) is over one cyclic shift zone, i.e. 0≦n≦Δ−1. Other means of combining can be used, such as combining the magnitude of the channel impulse responses.

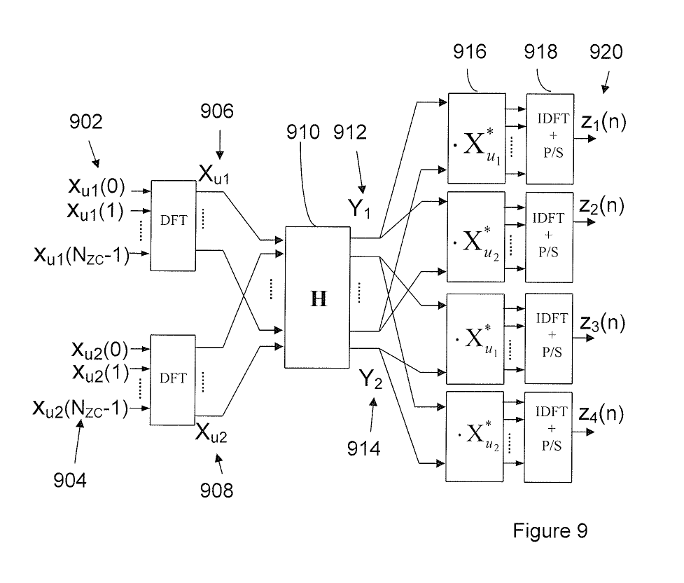

The second case is described in connection with FIG. 9: The two RA preambles 902, 904 may alternatively be generated from two different ZC root sequences u₁, and u₂, which is illustrated in FIG. 9. In this example, a cyclic shift of zero, i.e. no cyclic shift, is used when generating the RA preambles from the ZC root sequences u₁ and u₂ for the sake of simplicity and without losing the generality. Two TX and two RX antennas are used also in this example, i.e. 2×2 MIMO.

The received frequency domain sample after the equivalent frequency channel 910, is:

Y₁(k)=H₁₁(k)Xᵤ_{₁}(k)+H₁₂(k)Xᵤ_{₂}(k)

Y₂(k)=H₂₁(k)Xᵤ_{₁}(k)+H₂₂(k)Xᵤ_{₂}(k) (4)

Then, after the point-wise multiplication 916 at the output of the 4 branches, illustrated in FIG. 9, every frequency domain sample can be described as:

Y₁(k)·Xᵤ_{₁}^{*}(k)=H¹¹(k)Xᵤ_{₁}(k)·Xᵤ_{₁}^{*}(k)+H₁₂(k)Xᵤ_{₂}(k)·Xᵤ_{₁}^{*}(k)

Y₁(k)·Xᵤ_{₂}^{*}(k)=H¹¹(k)Xᵤ_{₁}(k)·Xᵤ_{₂}^{*}(k)+H₁₂(k)Xᵤ_{₂}(k)·Xᵤ_{₂}^{*}(k)

Y₂(k)·Xᵤ_{₁}^{*}(k)=H²¹(k)Xᵤ_{₁}(k)·Xᵤ_{₁}^{*}(k)+H₂₂(k)Xᵤ_{₂}(k)·Xᵤ_{₁}^{*}(k)

Y₂(k)·Xᵤ_{₂}^{*}(k)=H²¹(k)Xᵤ_{₁}(k)·Xᵤ_{₂}^{*}(k)+H₂₂(k)Xᵤ_{₂}(k)·Xᵤ_{₂}^{*}(k) (5)

After the IDFT and parallel to serial conversion 918, the received time domain signal is:

z₁(n)=h₁₁(n)+i₁; n=0,1, . . . , N_{ZC}−1

z₂(n)=h₁₂(n)+i₂; n=0,1, . . . , N_{ZC}−1

z₃(n)=h₂₁(n)+i₃; n=0,1, . . . , N_{ZC}−1

z₄(n)=h₂₂(n)+i₄; n=0,1, . . . , N_{ZC}−1 (6)

where i₁, i₂, i₃ and i₄ are interference terms, stemming from the non-zero cross correlation between different root sequences. To get an estimate of the round trip time, different ways of combining the output could be used, such as combining the magnitude of the impulse responses, or combining the powers of all channels as:

|z₁(n)|²+|z₂(n)|²+|z₃(n)|²+|z₄(n)|²=|h₁₁(n)|²+|h₁₂(n)|²+|h₂₁(n)|²+|h₂₂(n)|²+p

n=0,1, . . . ,Δ−1 (7)

where p represents the sum of the power of the interference terms i₁, i₂, i₃ and i₄.

To inform the terminal about which preambles it should use, the network node can provide root sequences or indexes of root sequences, and the corresponding cyclic shifts, to the terminal. Alternatively, indications of the respective root sequence and/or cyclic shift of the additional preambles could be signaled as offset values relative provided parameters of the first preamble, which offset values enable the terminal to derive all preambles that are to be used. Yet another method to signal multiple preambles to a mobile terminal is to specify predefined sets, where each set contains multiple preambles, and convey one or more sets to the terminal. Typically the sets would be enumerated and information containing the set number would be conveyed.

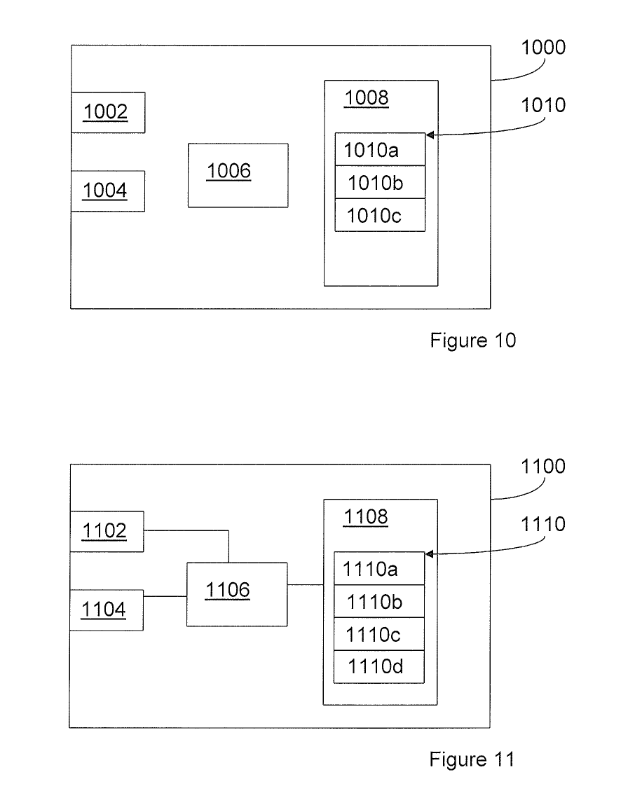

FIG. 10 schematically shows an embodiment of an arrangement 1000 in a mobile terminal, which also can be an alternative way of disclosing an embodiment of the arrangement in a mobile terminal illustrated in FIGS. 4a-b. Comprised in the arrangement 1000 are here a processing unit 1006, e.g. with a DSP (Digital Signal Processor) and an encoding and a decoding module. The processing unit 1006 can be a single unit or a plurality of units to perform different steps of procedures described herein. The arrangement 1000 also comprises the input unit 1002 for receiving signals from other network entities, and the output unit 1004 for output signal(s) to other network entities. The input unit 1002 and the output unit 1004 may be arranged as one in the hardware of the arrangement. The input unit 1002 and the output unit 1004 may be connected to a plurality of antenna ports, respectively.

Furthermore the arrangement 1000 comprises at least one computer program product 1008 in the form of a non-volatile memory, e.g. an EEPROM, a flash memory and a disk drive. The computer program product 1008 comprises a computer program 1010, which comprises code means, which when run in the processing unit 1006 in the mobile terminal arrangement 1000 causes the arrangement and/or the mobile terminal to perform the steps of the procedures described earlier in conjunction with FIGS. 3a-b.

Hence in the exemplary embodiments described, the code means in the computer program 1010 of the arrangement 1000 comprises a receiving module 1010a for receiving information on a non-transparent diversity scheme from a network node. The computer program may further comprise a generating module 1010b for generating e.g. more than one random access preamble according to the received information relating to a non-transparent diversity, in cases where such parameters need to be generated. The computer program further comprises a transmitting module 1010c for transmitting a network node assisted random access request to a network node, using at least two transmit antennas and applying the non-transparent diversity scheme, e.g. using different random access preambles on at least two transmit antennas, i.e. a first preamble on at least a first antenna, and a second preamble on at least a second antenna. The computer program 1010 is in the form of computer program code structured in computer program modules. The modules 1010a-c essentially perform the steps of the flows illustrated in FIGS. 3a-b to emulate the arrangements in mobile terminals illustrated in FIGS. 4a-b. In other words, when the different modules 1010a-c are run on the processing unit 1006, they correspond to the corresponding units 406a-b, 408a-b and 410b of FIGS. 4a-b.

Although the code means in the embodiment disclosed above in conjunction with FIG. 10, and the embodiment enclosed below in conjunction with FIG. 11, are implemented as computer program modules which when run on the processing unit causes the arrangement and/or mobile terminal to perform steps described above in the conjunction with figures mentioned above, at least one of the code means may in alternative embodiments be implemented at least partly as hardware circuits.

FIG. 11 schematically shows an embodiment of an arrangement 1100 in a network node, which also can be an alternative way of disclosing an embodiment of the arrangement in a network node illustrated in FIG. 6. The structure of the arrangement 1100, concerning input 1102, output 1104 and processing 1106 units; computer program product 1108 and computer program 1110, are similar to what is described above in conjunction with FIG. 10. The computer program product 1108 comprises a computer program 1110, which comprises code means, which when run in the processing unit 1106 in the network node arrangement 1100, causes the arrangement and/or the network node to perform the steps of the procedure described earlier in conjunction with FIG. 5.

Hence in the exemplary embodiments described, the code means in the computer program 1110 of the arrangement 1100 comprises a receiving module 1110a for receiving information on a mobile terminal. The computer program further comprises an obtaining module 1010b for obtaining information on a non-transparent diversity scheme to be used by the mobile terminal when transmitting a random access request, e.g. information relating to more than one random access preamble. The computer program further comprises a transmitting module 1010c for transmitting the information on the non-transparent diversity scheme to the mobile terminal. The receiving module 1110a may also be for receiving a random access request from the mobile terminal, which request is transmitted using at least two antennas and the non-transparent diversity scheme.

An advantage of embodiments of the invention is that it enables improvement of the link performance in network node assisted random access attempts. Further, the estimation of the round-trip time of the channels is improved.

While the invention has been described with reference to specific example embodiments, the description is in general only intended to illustrate the inventive concept and should not be taken as limiting the scope of the invention. The different features of the exemplary embodiments above may be combined in different ways according to need, requirements or preference. Although the description has mainly described an LTE system, the scope of the invention is not limited hereto. Embodiments of the invention may be applied in other systems with similar properties, such as e.g. IEEE 802.16m. The invention is generally defined by the following independent claims.

1-20. (canceled)

21. A method in a mobile terminal for transmission of a random access request using transmit diversity, the method comprising:
receiving, from a network node, a communication relating to network node assisted random access, said communication comprising information related to a non-transparent diversity scheme;
transmitting the network node assisted random access request to a network node, using more than one transmit antenna and applying the non-transparent diversity scheme.

22. The method of claim 21, wherein the information is received from the network node serving the mobile terminal, and where the network node assisted random access request is transmitted to said network node serving the mobile terminal.

23. The method of claim 21, wherein, in a handover situation, the information is received from the network node serving the mobile terminal, and where the network node assisted random access request is transmitted to a target network node.

24. The method of claim 21, wherein the received information relates to more than one random access preamble.

25. The method of claim 21, wherein more than one random access preamble is generated according to the received information, and wherein different random access preambles are used on at least two transmit antennas when transmitting the network node assisted random access request.

26. An arrangement in a mobile terminal adapted to transmit a random access request to a network node using transmit diversity, the arrangement comprising:
more than one transmit antenna;
a receiving unit, adapted to receive, from a network node, a communication relating to network node assisted random access, said communication comprising information on a non-transparent diversity scheme;
a transmitting unit, adapted to transmit the network node assisted random access request to a network node, using more than one transmit antenna and applying the non-transparent diversity scheme.

27. The arrangement of claim 26, wherein the receiving unit is further adapted to receive the communication from a serving network node, and wherein the transmitting unit is further adapted to transmit the network node assisted random access request to said serving network node.

28. The arrangement of claim 26, wherein the receiving unit is further adapted to receive the communication from a serving network node, and wherein the transmitting unit is further adapted to transmit the network node assisted random access request to a target network node.

29. The arrangement of claim 26, wherein the arrangement further comprises a generating unit adapted to generate more than one random access preamble according to the received information, and wherein the transmitting unit is further adapted to use different random access preambles on at least two transmit antennas when transmitting the network node assisted random access request.

30. A method in a network node for supporting transmission of a random access attempt of a mobile terminal in a wireless communication system, the method comprising:
obtaining information related to a non-transparent diversity scheme to be used by the mobile terminal when transmitting a network node assisted random access request to a network node;
transmitting a communication related to network node assisted RA to the mobile terminal, said communication comprising the obtained information related to a non-transparent diversity scheme to be used by the mobile terminal.

31. The method of claim 30, wherein the obtaining step comprises generating information related to a non-transparent diversity scheme within the network node.

32. The method of claim 30, wherein the obtaining step comprises obtaining information related to a non-transparent diversity scheme from another network node.

33. The method of claim 30, wherein the obtained information is related to at least two random access preambles to be used on at least two transmit antennas of the mobile terminal.

34. The method of claim 30, wherein the method further comprises:
receiving a network node assisted random access request being transmitted by the mobile terminal while using the non-transparent diversity scheme.

35. The method of claim 34, wherein the network node assisted random access request is received from a mobile terminal using at least two transmit antennas, and using different random access preambles on at least two of the transmit antennas.

36. An arrangement in a network node adapted to support a random access attempt of a mobile terminal in a wireless communication system, the arrangement comprising:
an obtaining unit, adapted to obtain information on a non-transparent diversity scheme to be used by the mobile terminal when transmitting a network node assisted random access request to a network node; and
a transmitting unit, adapted to transmit a communication related to network node assisted RA to the mobile terminal, said communication comprising the obtained information related to a non-transparent diversity scheme to be used by the mobile terminal

37. The arrangement of claim 36, wherein the obtaining unit is further adapted to generate information related to a non-transparent diversity.

38. The arrangement of claim 36, wherein the obtaining unit is further adapted to obtain information related to a non-transparent diversity scheme from another network node.

39. The arrangement of claim 36, wherein the arrangement further comprises a receiving unit, adapted to receive a network node assisted random access request being transmitted by the mobile terminal while using the non-transparent diversity scheme

40. The arrangement of claim 39, wherein the receiving unit is further adapted to receive a network node assisted random access request being transmitted by the mobile terminal while using at least two transmit antennas, and using different random access preambles on at least two of the transmit antennas.
